(19) United States
(12) Patent Application Publication
(10) Pub. No.: US 2025/0151752 A1
(43) Pub. Date: May 15, 2025

(54) FIBER COMPOSITE OF MULTI-COMPONENT FILAMENTS FOR EMULATING MEAT

(71) Applicant: Project Eaden GmbH, Berlin (DE)

(72) Inventors: David SCHMELZEISEN, Berlin (DE); Jan WILMKING, Berlin (DE)

(21) Appl. No.: 18/835,878

(22) PCT Filed: Nov. 10, 2022
(86) PCT No.: PCT/EP2022/081475

§ 371 Date: Aug. 5, 2024

(30) Foreign Application Priority Data
Nov. 12, 2021 (EP) 21207980.0
Jun. 22, 2022 (EP) 22180349.7

(51) Int. Cl. A23J 3/26; A23J 3/22; A23L 17/60; A23P 20/20; A23P 30/25

(52) U.S. Cl. CPC A23J 3/26; A23J 3/227; A23L 17/60; A23P 20/20; A23P 30/25

(57) ABSTRACT

The invention relates to a method for producing meat substitute products. In a first step, a plurality of multi-component filaments is provided, which are structured in such a way that they have a filler material and a casing material, wherein the casing material encases the filler material. The filaments contain water and additional proteins and/or fats. The filaments may also contain further additives, such as flavorings and colorings. In a second step, the filaments are bonded to one another, and a filament arrangement having predefined regions is created that is intended to imitate two meat emulation components of the meat substitute product. In a further aspect, the invention relates to a meat substitute product which is produced and/or producible by the method according to the invention. The invention also relates to a meat substitute product comprising a plurality of multi-component filaments bonded to one another, which form defined regions for at least two meat emulation components.

The invention belongs to the technical field of meat substitute production.

According to a first aspect, the invention relates to a method for producing meat substitute products. In a first step, a plurality of multi-component filaments is provided, which are structured in such a way that they have a filler material and a casing material, wherein the casing material encases the filler material. The filaments contain water and additional proteins and/or fats. The filaments may also contain further additives, such as flavorings and colorings. In a second step, the filaments are bonded to one another, and a filament arrangement having predefined regions is created that is intended to imitate two meat emulation components of the meat substitute product.

In a further aspect, the invention relates to a meat substitute product which is produced and/or producible by the method according to the invention.

The invention also relates to a meat substitute product comprising a plurality of multi-component filaments bonded to one another, which form defined regions for at least two meat emulation components.

### BACKGROUND TO THE INVENTION, PRIOR ART

In recent years, more and more people have decided to dispense with animal products in their nutrition. There may be many different reasons for doing so. This may be due, for example, to health issues, or may relate to ethical aspects concerning the treatment of animals and/or environmental and climate protection. In many supermarkets and organic food shops, the choice of meat alternatives is therefore growing. Consumers expect meat substitute products to meet high standards, so production processes for meat substitute products that are intended to be very similar to meat in taste and appearance is a major field of research that has considerable economic importance.

In order to produce suitable imitations of meat, it is essential first of all to identify relevant aspects regarding the consumption of meat as an animal product. The taste of meat depends on many factors, for example the animal, the livestock farming in terms of movement, feed and location, age, cut (e.g. fillet, rib-eye, etc.), trim, maturation (dry aged, smoked, etc.) and/or preparation (e.g. fried, roasted, grilled, cooked at low temperature). Tender meat is usually preferred to tough meat. Tender meat is due to muscle fibers being evenly and finely distributed, and to a high residual moisture content. The even, fine distribution of muscle fibers is fostered by frequent strain on the muscle. A high residual moisture level is ensured by the method of preparation.

The Maillard reaction also occurs on the surface of meat when it is heated. This refers to a complex reaction of fats, proteins and polysaccharides when heated, which results in surface browning and a slightly sweet taste. Due to the rising temperature inside the meat, its color and structure change. This change in color is largely associated with the myoglobin in the meat juice. This allows well-known cooking states to be set, such as blue, rare, medium rare, medium and/or well done. The temperature gradient between the core and the surface plays an important role here. When frying or roasting, the initial temperature and thickness of the meat also affects the cooking result to a major extent.

The fat contained in the meat is considered highly important. Fat is an important flavor carrier and gives the meat additional flavor. Beef cuts with a central fat area (e.g. entrecôte), or finely marbled cuts of meat such as Wagyu beef, are particularly popular. During the cooking process, fat is released and is absorbed into the meat. A very fine and even distribution of fat results in a particularly pleasant chewing sensation in addition to the taste. Pure fat, on the other hand, is very soft compared to muscle fibers and is more likely to be perceived by many people as annoying when chewing it.

The above remarks on animal meat products show that many aspects need to be taken into consideration in order to produce meat substitute products that come very close to real meat in terms of taste and appearance.

In the prior art, there are many approaches to producing meat substitute products suitable for human consumption. Production methods known from the prior art also use spinning processes in addition to extrusion processes.

For example, GB 1,081,627 A discloses a method for producing meat substitute products, in which hollow fibers are provided by a spinning method and are bonded together by means of an edible binder. The hollow fibers may also be filled with an edible material. The hollow fibers are filled in two steps, namely by providing the hollow fibers in a first step and then filling them. The exact arrangement and orientation of the fibers for the meat substitute product is not discussed in further detail.

U.S. Pat. No. 2,682,466 also discloses a method for producing a meat substitute product, in which a spinning process is also used. The spinning process provides filaments containing soybean proteins, for example. The filaments are combined into bundles or groups and are passed through a bath containing fat, for example beef or pork fat. U.S. Pat. No. 2,682,466 does not disclose a particular arrangement of the filaments in terms of how the filament types are positioned. Since the filaments are passed through animal fat, the meat substitute product thus produced is not suitable for vegetarians or vegans.

U.S. Pat. No. 4,235,935 discloses a method and an apparatus for producing a continuous strip of imitation bacon by low-temperature extrusion. Three differently colored doughs are provided to form a common strip containing three or more differently colored zones which are continuously and randomly varied in width. Differences in extrusion rates among the doughs may be used to impart crinkling and curling. Although spun fibers are mentioned, these are added to the doughs, which are then extruded. However, spinning the fibers is not the subject-matter of this patent.

In U.S. Pat. No. 4,423,083, a mixture consisting of coagulable proteins, alginate and water is firstly formed in order to produce the meat substitute product. This mixture is frozen to obtain vertically aligned fibers during freezing. The frozen pieces are then sliced in a direction parallel to the longitudinal axis before being thawed. The alginate contained therein is gelled by adding a gelling agent. Finally, white, aligned bundles of protein fibers are produced. No spinning process is described here.

GB 699 692 A likewise discloses a method for producing a meat substitute product, in which filaments of protein are provided by a spinning process. Fat is applied to the filaments by passing the filaments through a bath containing melted fat or fat in fluid form. The filaments are stretched to produce an orientation of the molecules therein. The moisture content of the filaments is then reduced and the filaments are then bonded together in order to be treated with fat. During the latter treatment with fat, the filaments are also brought into contact with a binder. A meat flavoring material may be added to preserve the meat flavor.

U.S. Pat. No. 3,840,679 pursues a different approach to producing a meat substitute product. The approach involving a spinning process that provides filaments is actually ruled out (see col. 3, lines 53 ff.). A dry protein mix containing a certain amount of edible proteins is provided. A moisture content is then adjusted, after which the mix is creped to form a workable protein dough sheet. The creped dough sheet is then aggregated and stabilized. After the stabilized mass has been heated, a coherent fiber mass that resembles meat in texture and eating quality is formed.

A method for producing a meat substitute product is also disclosed in WO 2021/191906 A1. This is done by providing at least one packed protein unit comprising at least one elongated protein strip. The at least one texturised protein strip is held by or within a retaining element. The at least one textured protein strip is then released from the retaining element and transferred to a production bed. One or more monolayers are formed thereby from texturised protein strips. The meat substitute product is provided in such a way, in particular, by substantially applying each monolayer one on top of another. In particular, the monolayers can be deposited according to a predefined plan. The protein strips can be coated with a functionalised material (also known as functionalizing) that partially or completely encases the protein strips. Treating, in particular coating, with a functionalised material can be carried out in different phases of the production process. The protein strips can be treated prior to packing, for example.

The currently known meat substitute products have a number of disadvantages, however. Most meat substitute products have difficulty retaining moisture in the meat substitute during frying or roasting. In meat that is actually of animal origin, a large proportion of the water is stored in the fibrous connective tissue and is distributed evenly throughout the meat. When a freshly fried or roasted piece of meat is cut, meat juice leaks out. Hardly any meat juices leak out, however, following a brief resting period (5-10 minutes) after frying or roasting. The water retention capacity is therefore time- and temperature-dependent. If, however, a currently known meat substitute product is roasted and then cut, it will be observed that hardly any or no meat juice flows out, or is stored in the meat fiber again after a resting period.

The meat substitute products known from the prior art also have difficulties in the placement of fat. In many cases, deep-frozen cocoa butter pieces measuring a few millimeters to a few centimeters are incorporated into the protein mass. The position of the fat pieces cannot be controlled precisely during the production process. The melting behavior of the cocoa butter pieces also differs from that of real animal fat in meat. Imitating the roasting behavior and the flavor is therefore possible to an approximate extent only.

One major problem with today's meat substitute products is their texture and the associated bite characteristics and their appearance. For that reason, meat substitute products are mainly confined to “processed food”, such as minced meat, meatballs and pressed or breaded cutlets. It is also difficult to integrate different components that imitate fat and/or fascia, for example, into meat substitute products, to form them in production processes, and/or to place them in a targeted manner.

The texture of meat substitute products that are available for purchase today ranges from a pulp to a mass of sticky fiber bundles. In process engineering terms, various plant proteins such as soy, peas or gluten are processed in extruders. The proteins cross-link due to friction and temperature. Depending on the base protein, the extruder settings, the temperature control and the water content, it is possible to adjust the texture. The result can vary from a pulp, to lumps a few millimeters in diameter, to fiber bundles with a fiber length of about 10 cm. Adjustment can be carried out on a trial-and-error basis. A precise explanation for the cross-linking of proteins in the extruder is a subject of research.

Approaches are also known from the prior art for producing meat substitute products using 3D printing, artificial cell growth and/or targeted fermentation in a bioreactor.

In 3D printing, a plurality of monomaterials such as protein mass and fat are combined with each other in a block to mimic meat structures.

WO 2020/152689 A1, for example, pursues an approach for producing a meat substitute product using a 3D printer or an additive manufacturing method. Layers comprising one or more protein-based and/or fat-based components are provided. 3D printing is carried out in such a way that one or more segments are provided that comprise protein-based components of the meat substitute product and which differ in their chemical composition from fat-based components. A non-homogenous distribution of protein- and fat-based components inside the meat substitute product is thus produced.

WO 2021/095034 A1 is a development of WO 2020/152689 A1, particularly in view of the fact that reference is made to WO 2020/152689 A1 with regard to the fat components (see p. 15, line 18) and the mimicking of muscle (see p. 29, line 14). In the method disclosed in WO 2021/095034 A1, a protein-containing material is firstly introduced into a print head (in the context of a 3D printer or additive manufacturing). One or more convoluted (i.e. folded) protein strands are then deposited onto a printer bed. A plurality of deposited strands are arranged in such a way that segments between the folds of the single or plurality of strands are substantially parallel with each other along their longitudinal axis.

Until now, the production speed of 3D printing processes has been very limited compared to extrudates, with the result that the fibers cannot be formed well and in particular that there is no appropriate orientation of the macromolecules. This has a disadvantageous effect on the bite resistance, in particular. It is also difficult for process engineering to produce the fiber structure in the desired manner, for example by placing a collagen casing a few micrometers thick around a protein core.

Artificial cell growth is a promising technology that in the view of many experts will be able to mimic animal meat very well in the long term. However, there are still substantial problems that need to be solved. For example, the cell growth medium is currently expensive and of animal origin. This means it is not yet entirely suitable for commercial use and is not suitable for vegans and vegetarians. Furthermore, the cells only grow three-dimensionally to only a limited extent. Scaffold structures are required for that purpose, but these are not sufficiently developed as yet. The problem of supplying nutrients for structures consisting of cells more than a few centimeters in length has not been solved. Another aspect is that the energy consumption during cell growth is very high.

The aim of fermenting proteins in the bioreactor is to produce proteins and/or to form microfibrils. Microfibrils, particularly, are very similar to the fibrous structures known from fungi. They form structures whose bite resistance are reminiscent of meat. However, such structures grow haphazardly. The superordinate structure of the fibrils does not show strong alignment in one direction. They bear a greater resemblance to sponges. Moreover, for process engineering reasons their growth is currently limited to smaller reactors. The volumes that can be produced are not yet scalable. The microfibril structures obtained contain one material. Other filler materials and flavorings have to be added at a later stage.

In the prior art, therefore, many approaches are pursued to produce meat substitute products that come very close to animal meat products in taste and appearance. It is not yet possible to mimic meat in a particularly successful and efficient manner using currently known methods and technologies, or only to a limited extent. There is therefore a need to efficiently produce meat substitute products that can mimic animal meat particularly well.

### THE OBJECT OF THE INVENTION

The object of the present invention was to overcome the disadvantages of the prior art. In particular, an object of the invention was to provide an improved, more efficient method for producing meat substitute products. The meat substitute products thus produced should also come realistically close to animal meat products in order to give the consumer a feeling that is as close as possible to the real thing in terms of preparation, taste and appearance. The method and the meat substitute product that can be produced with it should also be suitable for mass production.

### SUMMARY OF THE INVENTION

This object of the invention is achieved by the features of the independent claims. Advantageous embodiments of the invention are described in the dependent claims.

In one preferred embodiment, the invention relates to a method for producing a meat substitute product, the method comprising the following steps:
a) providing a plurality of multi-component filaments containing water and additional proteins and/or fats, wherein individual filaments comprise a casing material and a filler material, wherein the casing material encases the filler material,
b) creating a filament arrangement comprising the filaments provided in step a), wherein the filament arrangement has predefined regions for at least two meat emulation components, wherein the filaments are bonded to one another and the filament arrangement is formed as a meat substitute product using a pultrusion process.

In another preferred embodiment, the invention relates to a method for producing a meat substitute product, the method comprising the following steps:
a) providing a plurality of multi-component filaments containing water and additional proteins and/or fats, wherein each respective filament comprises a casing material and a filler material, wherein the casing material encases the filler material,
b) creating a filament arrangement having predefined regions for at least two meat emulation components and comprising the filaments provided in step a), wherein the filaments are bonded to one another and the filament arrangement is formed as a meat substitute product.

In a preferred embodiment, the multi-component filaments contain water and additional proteins and/or fats.

In another preferred embodiment, the multi-component filaments contain water and alginate and additional proteins, fats, flavorings and/or colorings.

A particular advantage of the method according to the invention is that the meat substitute product produced by it mimics animal meat products in a way that closely resembles real meat. This is due in particular to the fact that the method according to the invention allows the nutritional composition of the filaments to be adjusted in a targeted manner, preferably in step a), and to be arrange them accordingly in step b). This also has an advantageous effect on the composition of flavors, with the result consumers can be made to feel as if they are eating real animal meat.

A major advantage of the method according to the invention is also the effect that, by creating a filament arrangement having predefined regions for at least two meat emulation components, known meat components can be precisely mimicked with regard to their positioning and also their composition. In particular, it advantageously allows the meat substitute products to be produced in a reproducible manner, so that the meat substitute products are substantially the same in geometry and/or arrangement when the appropriate adjustments are made. The method according to the invention, and thus the meat substitute product itself, is advantageously programmable, whereby this programmability is preferably to be understood to mean that it is possible, in a targeted and reproducible manner, for the filaments to have certain ingredients and can be arranged in a specific manner to form true-to-detail meat emulation components in the meat substitute product. In particular, the programmability of the method according to the invention allows the exact position of different filament types to be allocated to particular positions in the meat substitute product. A filament type refers to a plurality of filaments that have substantially the same ingredients. The method therefore succeeds in incorporating filaments in the meat substitute product in a manner that is particularly close to the real thing.

For example, the filaments can be arranged in the meat substitute product in such a way that they can replicate muscle fibers and/or fats. A meat product can thus be advantageously simulated particularly precisely that contains not only muscle fibers and/or fats, but also other meat components such as tendons, skin, cartilage and/or bone. The structure of the meat substitute product can be mimicked, in particular, by designing the filaments in respect of their marbling and the exact position of meat emulation components. Marbling refers to the distribution of fatty tissue in the meat. Due to the differences in color between fat and muscle tissue, a visible pattern is created that is reminiscent of the structure of marble, which is why the term marbling is used. Marbling of the meat substitute product can be advantageously produced in a particularly efficient manner.

The method according to the invention advantageously means that the multi-component filaments can be provided in different geometries with different diameters. Many different meat products can thus be advantageously mimicked, without being limited to a particular type of meat. Possible meat varieties that can be advantageously mimicked are preferably selected from a group comprising but not limited to beef, lamb, pork, poultry, fish and/or mussels.

An advantage of the method according to the invention is that products can be individualised to a high degree, while simultaneously achieving a particularly high level of productivity. This means that the method according to the invention is also advantageously suitable for mass production and has proven to be particularly process-efficient and economical.

The filaments preferably comprise a plurality of components. Filament components preferably means ingredients, whereby these can be assigned to one or more subareas of a structure of the filaments. In preferred embodiments, the filament can thus have a structure comprising a core and a casing. In other preferred embodiments, the filament can have a lake-island structure.

In many prior-art methods, filaments are used that consist of only one material (a monomaterial). However, the special texture of animal meat is based on the combination of at least two materials in the muscle fiber. In the muscle fiber, a collagen sheath (the endomysium) ensheathes a protein core (myofibrils). The bite characteristics of meat result from biting through millions of collagen sheaths that enclose a juicy protein pulp and/or the slippage of parallel fiber bundles due to pressure from chewing. These bite characteristics cannot be mimicked using a monomaterial.

The method according to the invention eliminates this disadvantage of the prior art by providing multi-component filaments that can advantageously mimic animal meat components, such as muscle fibers, particularly well.

In particular, the structure and composition of the filaments have a very advantageous effect on the moisture, the taste profile and the nutrient profile of the meat substitute product. This makes it possible to precisely replicate the taste experience, the bite characteristics and the chewing characteristics with regard to moisture content.

The method according to the invention is itself particularly effective as a production process. The method also has an advantageous effect on the meat substitute product that can be produced with it.

The structure of the filaments, comprising a casing material and a filler material, has proven to be particularly advantageous, in that the casing material simultaneously forms a solid casing that encloses the filler material while also having sufficient elasticity. This allows the meat substitute product to be consumed in an optimal manner, for example when cutting with a knife or when inserting a fork into the meat substitute product. The filler material, in particular as an emulsion, also has a low viscosity, so a soft and juicy core is provided. In a subsequent heating process, for example when fried or roasted by a consumer, an optimal reaction can take place in order to mimic preparation like with a real meat product.

This advantageously allows the amount of moisture, i.e. water, in the meat substitute product to be regulated. In particular, it is possible for moisture to escape from the meat substitute product in a defined and/or regulated manner after the meat substitute product has been prepared and then cut. The leakage of moisture and/or the presence of a particular moisture content in the meat substitute product has an advantageous effect on the taste and also on the bite characteristics for consumers. It is well known that meat that is too dry is not ideal for consumption, particularly since it has to be chewed. The meat substitute product that can be produced by means of the method according to the invention advantageously eliminates the disadvantage of the prior art, namely unsuitable bite or chewing characteristics, in particular by allowing the moisture content in the meat substitute to be adjusted in a targeted manner.

In another preferred embodiment, step a) involves providing a plurality of multicomponent filaments containing water and additional proteins and/or fats, and/or other ingredients such as flavorings or colorings, wherein each respective filament comprises a casing material and a filler material, wherein the casing material encases the filler material.

The taste profile and nutrient profile can advantageously be adjusted inside the filaments in a targeted manner. Many different proteins, fats and/or other flavorings and other additives can be integrated in almost any combination into the filaments. The release of these substances can thus be controlled in a targeted manner. Flavorings, for example, are not released until the filaments are bitten through, or when the filaments come into contact with the tongue and/or palate. As a result, the release of flavor by a real piece of meat can be replicated better than in the prior art.

Within the meaning of the invention, a meat substitute product refers to a product which resembles a meat-based product as much as possible with regard to consistency, bite resistance and/or taste, but does not contain any raw materials of meat. This means that vegetarians and vegans can also enjoy products which are generally made exclusively from animal-based raw materials, but without consuming meat.

A multi-component filament refers to a filament which contains a plurality of components, in particular at least two components. In particular, a filament within the meaning of the invention is a fiber of any length. The filament preferably has a length that is practically unlimited, e.g. approximately 500 m (meters), 1000 m, 2000 m, or more.

Expressions such as “substantially”, “approximately”, etc. preferably describe a tolerance range of less than +40%, preferably less than +20%, particularly preferably less than +10%, even more preferably less than +5% and in particular less than +1%′, and include the exact value, in particular. The expression “partially” preferably describes at least 5%, particularly preferably at least 10%, and in particular at least 20%, in some cases at least 40%.

The filament is preferably structured in such a way that a filament comprises a casing material and a filler material, wherein the casing material encases the filler material. The casing material thus refers preferably to the entirety of ingredients that surround the filler material. The casing material is therefore located preferably between the surroundings and the filler material. The filler material preferably refers to the entirety of ingredients that are found inside a volume formed by the casing material. What is meant by this, in particular, is that the filaments are not hollow and have two structural components, i.e. components for forming a structure, namely the casing material and the filler material. What is preferably meant by the expression “entirety of ingredients” is that the casing material and/or the filler material may have one or more ingredients.

In preferred embodiments, the filament has a core-casing structure. In other preferred embodiments, the filament may have a lake-island structure.

Within the meaning of the invention, a core-casing structure preferably refers to a kind of structure in which the filler material forms a core, and the casing material forms the casing that ensheathes the core.

Within the meaning of the invention, a lake-island structure preferably refers to a kind of structure in which the filler material is formed by a larger number of inner structural components for the filament and is surrounded by the casing material. The inner structural components are characterized by a particularly filigree and/or small diameter, for example less than approximately 40 μm (micrometers). A lake-island structure can have a plurality of cores. The lake-island structure advantageously allows finer filament cores to be produced, since it is possible for multiple cores to be drawn off in a bundle from a nozzle opening, for example.

It is preferred in this regard that the filler material has a diameter of between approximately 5 and 150 μm. The filament itself can preferably have a diameter of between approximately 40 μm and 10 mm.

The method according to the invention advantageously allows filaments to be produced which are particularly good at forming meat emulation components in terms of composition, taste, bite characteristics and/or appearance.

In another preferred embodiment, the method is characterized in that the filaments contain cellulose and/or proteins, in particular in addition to the alginate. Cellulose and/or proteins are preferably present in the form of cellulose fibers and/or protein fibers. The mouthfeel is advantageously improved with regard to chewing resistance and juiciness when a consumer is consuming the meat substitute product. Due to the cellulose, in particular the cellulose fibers, liquid is preferably released substantially evenly in the mouth, such that the release of meat juice can be imitated and/or mimicked in the mouth itself. Due to the proteins, in particular the protein fibers, the chewing resistance is advantageously increased, which likewise improves the imitation of eating real meat. It is particularly preferred that the preferred cellulose and/or proteins are present when the filament has a core-casing structure.

In preferred embodiments, the filaments have a cross-sectional area of between 0.03 and 3 mm2, preferably between 0.04 and 2.5 mm2, particularly preferably between 0.08 and 0.3 mm2.

The aforementioned cross-sectional areas of the filaments have proven to be advantageous in that it is possible to form particularly fine marbling of the meat emulation components. The filaments can also be transferred particularly easily in a pultrusion process and/or through an arrangement of one more grids, in order to be bundled and to form the meat substitute product.

In preferred embodiments, between 50 and 10,000 filaments, for example 100 to 5,000, or 500 to 2,000 filaments, are bonded to one another in the meat substitute product.

The number of filaments can be used to specify the size and/or compactness, in particular the density of filaments, for individual meat emulation components in the meat substitute product. The taste experience can be intensified by using a greater number of filaments to imitate a meat component. For example, a large number of protein filaments can provide consumers with a particularly intense meat flavor experience. A large number of fat filaments can provide the consumer with a particularly intense flavor of fat. The texture of the meat substitute product can also be adapted and/or adjusted by means of the filaments. This means that, by designing the filaments in terms of density, number and/or size, it is possible to regulate the firmness and/or outer appearance of the meat substitute product, particularly with regard to its marbling and/or coloring.

Within the meaning of the invention, meat emulation components are preferably those components of the meat substitute product that imitate the meat components by means of the filaments. Preferred imitated meat components provided in the form of meat emulation components are selected from a group comprising muscles, fat, tendons, skin, cartilage and/or bone. The method according to the invention can therefore be used to produce a meat substitute product that is particularly close to the real thing. This is particularly due to the fact that protein and/or fat filaments can be provided particularly efficiently. For example, muscles and/or fat can be replicated as meat emulation components in a way that closely resembles real meat.

A fat filament preferably refers to a filament that is provided to replicate fat. The expressions “fat filament” and “lipid filament” can be used synonymously in the context of the invention. A protein filament can be used, in particular, to replicate muscles. Protein and fat filaments differ in their ingredients.

The inventors have discovered, for example, that in order to form a protein filament as a meat emulation component for muscles, a particularly advantageous composition is formed by approximately 70-90% water, approximately 5-20% vegetable proteins (obtained from sunflowers, peas, soy, rice or algae, for example), approximately 1-10% methyl cellulose, 1-5% alginate, approximately 0-10% fat, approximately 0%-3% colorings and approximately 0-3% flavorings.

In preferred embodiments, the protein filaments have a water content greater than 26%, preferably greater than 30%, particularly greater than 35%, 40%, 45%, or greater than 50%, or even greater than 60%.

The relatively high water content in the filaments has an advantageous effect on the taste experience during consumption that is provided by the meat substitute product that can be produced according to the invention. Particularly when methyl cellulose is used, a high water or moisture content remains after the meat substitute product has been prepared, so the consumer is given a strong feeling of juiciness. Water (moisture) can also be released after cutting the meat substitute product, so a particularly realistic feeling can be imparted to the consumer.

In particular, no texturised proteins of the kind known from the teaching of WO 2021/191906 A1 are used. According to the invention, the proteins are preferably dispersed in an emulsion inside the filler material and encased by (cross-linked) alginate as casing material. This is proven to be particularly advantageous in several respects. It is advantageous that the proteins are not denatured in the production process, thus ensuring that the molecular structure and the biofunctionality of the proteins is retained. Greater juiciness results in the producible meat substitute product as such, thus enhancing the taste experience for the consumer. When preparing the meat substitute product by applying heat, e.g. when frying or roasting, the proteins can cross-link, so the degree of doneness can be optimized by adjusting the heat (temperature) and/or the duration of the heat. This allows degrees of doneness to be advantageously imitated, as is common in the case of real meat.

To form a fat filament as a meat emulation component, it has been found that a particularly advantageous composition is approximately 50%-90% water, approximately 10%-40% vegetable fat (e.g. palm oil, cocoa butter and/or sunflower oil), approximately 5-20% vegetable proteins (e.g. obtained from sunflowers), peas, soy, rice, algae), approximately 1%-5% methyl cellulose, approximately 0%-5% colorings and approximately 0%-5% flavorings.

The method according to the invention advantageously allows fat filaments to be incorporated in a filament arrangement particularly precisely and effectively, in order to provide fat as a meat emulation component. It is preferred in this regard that the filament itself contains fat. This advantageously obviates the need for additional process steps, for example in which the filament is drawn through a bath containing fat. In some prior-art methods, it is also common practice to integrate fat into the meat substitute product by using fat in an edible binder and bringing it into contacting it with the filaments. Such process steps render the process flow inefficient. These disadvantages of the prior art are advantageously eliminated by allowing a fat filament to be provided directly.

Proteins are made up of many different amino acids that are linked together. They are sources of nutrients for the final consumer. For the meat substitute product itself, proteins can also be used as providers of structure on different levels of the meat substitute product, namely on the molecular level, the filament level, the filament bundle level and/or in the meat substitute product itself. The chewing characteristics can be adjusted via the structure. The filaments can also be processed particularly efficiently. Within the meaning of the invention, it is preferable to use proteins which can cross-link at a temperature between approximately 20° C.-8° C. and/or within approximately 1 min-60 min (minutes) and/or which can be crosslinked enzymatically (using transglutaminase, for example).

A variety of different sources for the proteins can be used within the scope of the invention. It may be preferably in some embodiments of the invention that the proteins originate from plants and/or animals. In other preferred embodiments, the proteins may be animal-based proteins grown in the laboratory (“lab grown proteins”) and/or plant-based proteins grown in the laboratory (e.g. using “fermented” or “precision fermented” processes). Fermentation utilizes the protein content and the rapid growth of microorganisms to efficiently provide the proteins as such. During fermentation, the microorganisms that multiply by this process are themselves the preferred ingredients for the proteins. During precision fermentation, microbial hosts are used as cell factories to produce the proteins. The microbial hosts can preferably be programmed in such a way that they are able to provide complex organic molecules such as proteins. In other preferred embodiments, the proteins originate from amino acids synthesised in the laboratory.

Fats are also one of the most important sources of energy for the human body. Flavorings can be dissolved particularly well in fat. Fats are also relevant for the taste of the meat substitute product, because they are excellent flavor carriers. Fat is also a carrier of certain vitamins that are valuable for humans, such as vitamins A, D and/or E. The fats are preferably vegetable fats.

In step b), it is preferred that a filament arrangement having predefined regions for at least two meat emulation components is created that comprises the filaments provided in step a). The filaments are preferably bonded to one another, and the filament arrangement is formed as a meat substitute product.

In the context of the invention, a filament arrangement refers to an arrangement comprising the filaments provided. A filament arrangement may comprise one or more filament types, in particular to form one or more meat emulation components.

What is meant by bonding the filaments is that the filaments are bonded together in such a way that they do not fall apart easily, so as to form a stable meat substitute product once the method has been carried out.

Forming the filaments involves pressing and/or cutting the filaments and/or the filament arrangement. It is also preferred that the filaments are combined to form bundles. Forming, comprising pressing and/or cutting, can also apply to the filament bundles. In a filament bundle, the filaments are preferably bonded already to one another. This advantageously allows different forms for the meat substitute product to be produced, such as steaks, patties, fish fillets and/or chicken thighs.

The finished meat substitute product preferably contains proportions of the filaments provided in step a). In a preferred embodiment, the meat substitute product contains approximately 0.5%-100%, or 0.5%-99%, preferably approximately 1-50%, or approximately 1-20%, particularly preferably approximately 2-10%, of the filaments provided in step a).

The preferred method can be used advantageously to adjust easily and precisely the proportion of the filaments provided in step a) in the meat substitute product itself. This allows the composition of the meat substitute product to be adjusted in a targeted manner, which can advantageously affect the method of preparation, the taste experience, the chewing characteristics and/or its external appearance. Using a pultrusion process allows the proportions in the meat substitute product of the filaments provided in step a) to be adjusted to particularly good effect.

In another preferred embodiment, the casing material comprises alginate, wherein preferably the casing material forms an outer casing comprising cross-linked alginate on an outer side of the filament, and alginate is present inside the filler material.

Alginate is chemically cross-linked via a setting reaction. In an aqueous solution and in the presence of bivalent metal ions (e.g. Ca2+ ions), the previously single-chain, water-soluble alginate macromolecules cross-link. The result is a calcium alginate that is insoluble in water. Calcium lactates are preferably used as setting agents. Setting agents other than calcium lactates can also be used.

In the method according to the invention, the filaments are preferably provided by using alginate as the starting component. It has been shown that alginate is advantageously an excellent collagen substitute. Collagens are structural proteins in the connective tissue of multicellular animals. Collagens can be found, inter alia, in the white, inelastic fibers of tendons, ligaments, bones and cartilage. Alginate has been shown to be a particularly efficient substitute for collagen, which advantageously means that animal collagen can be completely dispensed with.

Alginate also has an advantageous effect on the structuration of the filaments. In particular, alginate provides strength as a casing material for a single filament. This advantageously allows mechanical properties of the filaments to be optimized over a wide range, which means that meat substitute products ranging from very soft to very tough can be produced.

Filaments are advantageously held together particularly reliably in the filament arrangement and/or the filament bundle by the cross-linked alginate acting as an outer casing. Meat emulation components, such as muscle strands, fatty tissue and/or other connective tissue, can thus be formed by means of the collagen and the distribution and/or arrangement of the filaments. The meat emulation components can therefore be realistically close in composition and texture to different types of meat.

Within the meaning of the invention, cross-linked alginate refers to an alginate which acts as a casing material to form the outer sheath of a filament. In particular, the cross-linked alginate is characterized by a cross-linked network of alginate molecules. The bite resistance and/or toughness can be advantageously regulated in this way.

In other preferred embodiments, it is also possible to use chitosan, particularly in combination with alginate. Chitosan is advantageously used for cross-linking and can also have an antimicrobial effect, thus extending the shelf life of the meat substitute product in a systematic manner.

In another preferred embodiment, the method is characterized in that the filler material includes a thickener, a binder and/or an emulsifier, wherein the filler material preferably includes methyl cellulose.

In another preferred embodiment, the method is characterized in that the filler material is selected from a group comprising alginate, fat, proteins, preferably soy proteins and/or pea proteins and/or sunflower protein, calcium lactate, calcium chloride, water, methyl cellulose, lipids, flavorings and/or colorings.

Alginate, in particular, has also proven to be an advantageous ingredient in the filler material, as it is particularly good at binding other ingredients such as flavorings and/or colorings. In particular, alginate can thus be included in both the filler material and the casing material, preferably forming a network in the casing material, in particular an alginate casing.

In other preferred embodiments of the method according to the invention, alginate can also be added from the outside, in which case a setting agent, preferably calcium lactate, is used as a component of the filler material.

Calcium lactate also forms a suitable setting agent for the alginate, in particular to form the casing material. The calcium cations of react with the alginate to form a network of extensively cross-linked alginate. Therefore, in the context of the invention, the casing material can also be described as an alginate casing.

In other preferred embodiments, it is also possible to use calcium sulfate. The calcium sulfate advantageously allows the alginate to form a solid bond. Before reacting with the calcium sulfate, the alginate may be in a gel-like state that is solidified by reaction with the calcium sulfate.

Methyl cellulose is advantageous in that it favors the preservation of moisture in the meat substitute product. In particular, the moisture within the alginate casing can be chemically stored in the methyl cellulose in the filler material and mechanically stored in a polymer structure of the cross-linked proteins. The taste experience can therefore be replicated very well, especially with regard to the residual moisture.

By adding a defined amount of methyl cellulose, it is also possible to advantageously control the water retention capacity when frying or roasting the meat substitute product, such that a residual amount of moisture remains when the meat substitute product is fried or roasted. This is due in particular to the fact that methyl cellulose also preferably forms a network, such that the water cannot escape in unlimited quantities when increasing the temperature, for example during frying or roasting.

Methyl cellulose also has an advantageous effect on the fat fibers. To form fat fibers, methyl cellulose wraps itself around the fat in such a way that the filaments are stably bonded to one another, so as to advantageously prevent the filaments from falling apart.

Lipids are particularly relevant when it comes to providing fat filaments. Lipids are preferably also used to create protein filaments for forming muscles as meat emulation components. They are preferably used in a proportion of up to approximately 10% to provide protein filaments. In order to provide fat filaments, lipids are preferably used in a greater proportion.

Thickeners are used, in particular, to advantageously affect the consistency and/or texture of the meat substitute product. Undesirable separation processes that occur during storage, during the production process and/or in the meat substitute product, such as the settling of particles and/or a separation of phases, can be slowed down and/or prevented.

Binders allow ingredients to form chemical bonds at phase boundaries, or facilitate such processes, and/or trigger or amplify effects such as cohesion, adsorption and/or adhesion. They bind ingredients by absorbing them, attaching to them, holding them together, cross-linking and/or bonding them together. The binders are preferably selection from a group comprising pectins (E440), guar gum (E412), carob bean gum (E410), starch, sago, gum arabic (E414), carrageenan (E407), xanthan gum (E415), alginic acid and/or alginates (E400-E405).

Emulsifiers are additives that are used to mix and stabilize two fluids that cannot be mixed with each other, such as oil and water, to form a finely dispersed mixture known as an emulsion. A similar principle applies to the mixing of solid, insoluble substances in a liquid to stabilize a so-called suspension. An emulsifier that acts in water preferably has a substructure that is highly water-soluble (e.g. a polyol) and a fat-soluble substructure (e.g. a fatty alcohol or fatty acid) in its molecule. An emulsifier is preferably selected from a group comprising lecithins, and monoglycerides and/or diglycerides of fatty acids.

The preferred use of soy proteins, pea proteins and/or sunflower proteins has been shown to be advantageous in that these proteins are cost-effective in their procurement and enable the filaments to be provided in a process-efficient manner. In the prior art, they have proven to be suitable proteins for forming a suitable structural agent and also nutrient suppliers for the consumer.

Flavorings are ingredients that are intended to mimic specific odors and/or tastes. Many flavors can be attributed to specific organic compounds. These specific flavorings belong to chemically different classes of organic substances. In many cases, they are aromatic hydrocarbons, esters, terpenes, alkyl pyrazines, aldehydes and/or ketones.

Colorings are colorants that are soluble in solvents such as water or other solvents. Plant-based colorings are preferably used in the context of the invention. Examples include beetroot juice and/or radish concentrates, carrot skins and/or grape skins. These advantageously provide good coloring results, so as to give the meat emulation components a particularly realistic color, such as the reddish coloring of a steak or burger patty. For example, muscles with light red or dark red coloring, and fat, can be simulated by coloring filaments white. The method according to the invention advantageously succeeds at simulating different areas of real meat particularly well by the arrangement of filaments having predefined regions.

In another preferred embodiment, the method is characterized in that a step a-1) of producing the multi-component filaments by a spinning process and/or an extrusion process is carried out before step a).

Spinning processes, or simply spinning, preferably refers to processes for providing continuous fibers and thus filaments from a polymer or a mixture. The spinning process is therefore a specific form of extrusion, in which a spinning nozzle is used to provide the filaments. Spinning processes have advantageously proven to be particularly efficient and simple methods for providing the filaments for step a).

The spinning process is preferably selected from a group comprising wet spinning, dry spinning, dry-wet spinning, melt spinning, gel or semi-melt spinning, and/or electrospinning.

In dry spinning, the ingredients are dissolved in a volatile solvent and the solution is pumped through a spinning nozzle with holes (from one to thousands). When the filaments exit the spinning nozzle, the solvent is evaporated by contact with heated air, with the result that the filaments solidify and can be gathered.

Dry-wet spinning is a spinning process in which the starting materials are dissolved in a suitable solvent, then extruded under heat and pressure through an air gap before entering a coagulation bath. The filaments thus produced are then washed and dried before being subjected to further steps of the process, for example heat treatment and/or stretching.

Melt spinning is characterized by the starting materials being melted and/or crosslinked by heat. After exiting the spinning nozzle, the filaments pass through a cooling area and are then wound, in particular using winders and reels in order to obtain more efficient alignment of the proteins and/or fats, for example to prevent the creation of cavities.

Gel spinning is a special spinning process for achieving high strength and/or other special properties. During extrusion, the starting materials are not in a completely liquid state. In particular, the polymer chains are not completely separated, as would be the case in a solution. Instead, the polymer chains are linked at various points in the form of liquid crystals. This creates strong forces between the resultant chains, which can significantly increase their tensile strength. The filaments are also formed with a high degree of alignment, thus increasing their strength.

Electrospinning refers to a spinning process in which the filament is collected from the spinning nozzle by applying an electrical voltage between the spinning nozzle and a collection point. Electrospinning does not require any coagulation chemistry in order to provide solid filaments.

Wet spinning has proven to be particularly suitable for providing the filaments for the context of the invention. In wet spinning, the ingredients are mixed and/or dissolved, preferably with specific values for their proportions and/or concentrations, such that a desired viscosity is obtained. The ingredients are preferably to be understood as starting materials which can be filled into a tank, for example. These are then conveyed through the spinning nozzle under heat and/or pressure to provide the filaments. The filaments are extruded into a coagulation bath. The coagulation bath contains a fluid comprising a setting agent (calcium lactate, for example). Compounds containing calcium have been found to be particularly good setting agents, in particular to form the alginate casing comprising cross-linked alginate as casing material. This means that the filament provided advantageously has a suitable strength and stability in the coagulation bath already. The filaments can then be subjected particularly easily to further processing steps, such as storage on a roll and/or stretching of the filaments. Preferred steps for performing wet spinning include heating the ingredients in the form of a mixture and/or solution in a suitable tank and/or vessel, transferring the mixture and/or the solution to the spinning nozzle and/or introducing the filaments in into an appropriate coagulation bath.

The coagulation bath refers to a vessel or container containing a coagulant. The coagulant comprises a means for coagulating and/or cross-linking proteins. In the context of the invention, coagulants containing calcium have proved to be particularly advantageous.

It is preferred, in particular, that the spinning nozzle is located directly in the coagulation bath so that the filaments are suitably hardened in a particularly fast and effective manner, due in particular to the alginate being cross-linked.

The geometry and the mechanical and/or physical properties of the filaments can be adjusted using wet spinning process parameters. Possible process parameters can be selected from a group comprising a conveying speed of the conveyor, the pressure, the draw-off speed, the temperature of the tank into which the starting materials are filled, the temperature during conveying to the spinning nozzle, the temperature of the spinning nozzle, the structure and/or the geometry of the spinning nozzle and/or the temperature in the coagulation bath.

For example, the pressure can be 2-100 bar, the draw-off speed approximately 2-200 m/min, the temperature of the tank approximately 0° C.-80° C., the temperature during conveying to the spinning nozzle approximately 20° C.-80° C. and/or the temperature of the coagulation bath approximately 0° C.-80° C.

It is also particularly advantageous to use methyl cellulose, particularly in relation to a spinning process and in particular a wet spinning process, as the methyl cellulose prevents fat filaments in particular from leaving the spinning nozzle in a pulpy state, but can exit in the form of filaments.

An extrusion process refers to a process in which malleable to viscous masses, in particular, are continuously pressed out of a molding orifice under pressure. The molded mass is referred to as extrudate and generally hardens on exiting the orifice due to cooling, heating and/or a chemical reaction. Extrusion processes can be advantageously used to produce filaments having multisided profiles with any kind of cross-section, in particular complex cross-sections, and of any length. Spinning processes are a special type of extrusion process. Other extrusion processes that allow multi-component filaments comprising a casing material and a filler material are preferably to be used to provide the filaments.

The structure of the filaments is preferably formed when providing the filaments in step a). In one embodiment, the filaments comprising the casing material and the filler material are provided by a spinning process and/or an extrusion process. The filaments are preferably provided by a spinning process and/or extrusion process as part of a spherification process. In the context of the invention, alginate as a reactive biopolymer forms an outer casing in the coagulation bath by reacting with divalent metal ions, for example Ca2+calcium ions, so as to provide the casing material as a cross-linked alginate. A casing material that encloses a low-viscosity core, i.e. a low-viscosity filler material, can be advantageously formed, wherein the filler material may include proteins, fats, colorings and or flavorings. In contrast to prior-art meat substitute products or methods, the filler material in particular is present as an emulsion inside the casing material. This results from preferred steps of the method, in particular the step of providing the filaments, and can also be observed in the meat substitute product itself.

In another preferred embodiment, in step a-1), a conveying means conveys a spinning mass containing water, alginate and methyl cellulose, and additional proteins and/or fats, to a spinning nozzle, and/or the temperature between the conveying means and the spinning nozzle is between 20° C. and 80° C.

In another preferred embodiment, the method is characterized in that, in step a-1), a conveying means conveys a spinning mass containing water, alginate and methyl cellulose, and additional proteins and/or fats, to a spinning nozzle, and/or the temperature between the conveying means and the spinning nozzle is between 20° C. and 180° C., for example between 20° C. and 80° C.

By means of the conveying means, the spinning mass can be advantageously conveyed to the spinning nozzle in an efficient manner. The specified temperature range between the conveying and the spinning nozzle is advantageous in that it already allows cross-linking of the proteins.

The spinning mass comprises the entirety of the starting materials that are delivered from the spinning nozzle to form the filaments. The starting materials preferably include water, alginate, methyl cellulose and additional proteins and/or fats. It may be preferably, in particular, that the spinning nozzle is already present in the coagulation bath, in order to allow cross-linking of the alginate immediately after it exits the spinning nozzle, thus resulting in direct contact between the separated filament and the calcium.

In other preferred embodiments, alginate can be cross-linked as a collagen substitute in the spinning nozzle and/or before the spinning nozzle.

The spinning nozzle refers to a component of an apparatus or system that can carry out the spinning process. The spinning nozzle has at least one orifice and preferably a plurality of orifices. A plurality of orifices advantageously allows a multiple filaments to be formed. It is preferred that the filaments exiting a spinning nozzle having a plurality of orifices are substantially identical in terms of their ingredients and structure. In this way, a large number of similar filaments can be provided in a process-efficient manner.

A conveying means refers to a component of the apparatus for carrying out the spinning process and is used to convey the spinning mass in the direction of the spinning nozzle. The conveying means is preferably selected from a group comprising a pump and/or compressed air. Compressed air refers here to air that has been compressed and is used to convey the spinning mass in the direction of the spinning nozzle.

In another preferred embodiment, the method is characterized in that the filaments in step a-1) are contacted after exiting a spinning nozzle with a solution containing calcium, calcium lactate and/or alginate, wherein the temperature of the solution is preferably between 0° C. and approximately 80° C.

Bringing the filament exiting the spinning nozzle into contact with the solution containing calcium, calcium lactate and/or alginate advantageously results in particularly good cross-linking of the alginate. The cross-linked alginate preferably forms an outer casing of the filament. The cross-linked alginate has also proven to be advantageously in that it allows the filaments to be bonded to one another particularly well in further steps of the method.

The specified temperature range has also proven to be advantageous in that a particularly fast reaction to form cross-linked alginate can be achieved.

The cross-linked alginate can preferably also be formed in the spinning nozzle and/or before entering the spinning nozzle, so to provide the outer casing of the filament. It may also be preferable to use a setting agent such as calcium lactate as a starting material and to then bring the extrudate into contact with a sprayed and/or liquid solution after it exits a nozzle. An alginate film forms on the surface of the filament and is bound by the calcium in the protein core. The filaments can also be drawn off and stretched. The variant described above, in which the crosslinked alginate is formed in and/or before entering the nozzle, can also be carried out as part of a spinning process, i.e. with a spinning nozzle.

It is also highly advantageous that there is no need for additional steps, such as freezing the solution and/or the filament, in order to align the proteins along a longitudinal axis of the filament. Instead, the method according to the invention is able to align the proteins along a longitudinal axis of the filament immediately after it exits the spinning nozzle and/or the extrusion process. This can be done, for example, by providing a suitable flow in the coagulation bath and/or an increased draw-off speed. The mechanical properties of the proteins increase significantly due to the longitudinal alignment of the proteins. This means that the anisotropic material behavior of meat can also be imitated particularly well even when very fine fibers (with a cross-section less than approximately 200 microns) are used to mimic meat fibers. The cross-linking of the proteins allows the filaments to achieve particularly high strength and to be stretched well. Stretching is particularly advantageous with regard to aligning the macromolecules of the proteins.

The alginate reacts with the setting agent, preferably the calcium lactate, from the coagulation bath. The reaction takes place on the surface of the filament as soon as the spinning mass exits the spinning nozzle. Advantageously, more than approximately 95% of the water can be bound by the alginate. Flavorings, colorings and/or other functional substances can also be bound well in the alginate.

In another preferred embodiment, the method is characterized in that the filaments in step a-1) are drawn off from a spinning nozzle, dried and/or stretched and then stored, preferably on a roll, before the filaments are used in step b).

Drawing off the filament from a spinning nozzle refers to the filament exiting the spinning nozzle and solidifying in the coagulation bath.

In other preferred embodiments, the filaments are dried, washed and/or compacted after they have been drawn off. The drying, washing and/or compacting can preferably be carried out by guiding the filaments over conveyor rolls and drawing them off by means of a winder. It may also be preferable to carry out the drying, washing and/or compacting in such a way that the filaments are placed on a conveyor belt and guided by means of the conveyor belt through one or more of the aforementioned steps.

Washing is preferably carried out after the filaments are brought into contact with the coagulation liquid, which is preferably located inside the coagulation bath. The surface of the filaments is preferably wetted with calcium lactate and/or water at the outlet of the coagulation bath. Additional wash baths can preferably be inserted downstream from the coagulation bath. The filaments can be drawn through these wash baths after the coagulation bath. Washing is carried out in these wash baths (or in one wash bath), so that residues of the coagulation liquid are advantageously washed off. Water is preferably used as the detergent.

Drying the filament refers to a step in which the filament is brought into contact with air and/or exposed to microwaves and/or radiation (for example infrared radiation) and/or heated surfaces (for example galettes) at a particular temperature and/or within a particular period of time, in order to evaporate any residual moisture that remains due to the filament being in contact with a liquid containing calcium and/or calcium lactate. Drying can preferably also be carried out by pressing out liquid mechanically. In addition to the drying methods described above, the filaments can be guided for that purpose to each other, and with a certain contact pressure, between a plurality of continuously running, preferably perforated belts.

The filaments are preferably compacted during or after the filaments are dried. During compacting, a plurality of filaments are compacted to form a filament bundle, i.e. they are packed or bundled together more densely. In particular, a plurality of filaments drawn off substantially parallel with each other can be compacted into filament bundles. In order to compact them, the preferably substantially parallel filaments are preferably guided over conical rolls, for example, conveyed between a plurality of preferably perforated conveyor belts and/or twisted (twisted around each other and/or helically wound around each other). The different steps (guiding over conical rolls, conveying between a plurality of conveyor belts, twisting) can preferably also be combined with each other. Compacting advantageously allows bundles containing approximately 50-10,000 filaments, also 100-5,000 or 500-2,000 filaments, for example, to be wound directly in cross-section onto reels.

When stretching the filament, the provided filament is preferably lengthened. This can be done, for example, by drawing off the filament from the spinning nozzle at a higher speed. Stretching can affect the fiber fineness of the filaments. In particular, the proteins can align themselves more optimally along a longitudinal axis of the filaments.

Storage of the filaments preferably refers to placing the provided filaments into stock. In particular, the filaments are kept in storage because they will be needed again later, for example for further steps in producing the meat substitute product.

Storage can preferably also be on a roll, before the filaments are used in step b). By storing the filaments on a roll, they can advantageously be swapped particularly easily, for example if other filament arrangements are required in process in step b). There can be many examples of the need to change the filament arrangement. This is important, for example, if problems arise during production that require the filaments and therefore the rolls to be changed. This may also be important if, during the production process, different requirements for forming a meat emulation component and/or the meat substitute product are expressed. Storage on rolls therefore has advantages for production of the meat substitute product that are particularly process-efficient. Storing the filaments also allows them to be transported, to be directly subjected to further processing or to other advantageous change processes (for example maturation or fermentation processes).

In the context of the invention, a roll refers to a device onto which the filament can be wound. The expression “roll” and “winder” can therefore be used synonymously. In particular, the draw-off speed of the filament can be regulated by rotation of the roll. For example, the filament can be conveyed out of the spinning nozzle into the coagulation bath and then onto the roll. Different windings on the roll, such a cross-winding, can improve the further processability.

In another preferred embodiment, the method is characterized in that the filaments for the filament arrangement in predefined regions are drawn through a guide, preferably a grid, for positioning a plurality of filaments containing different ingredients for meat emulation components, and are pressed together.

In the context of the invention, a guide means, in particular, one or more components that allow a direction to be specified for a filament. In particular, the guide specifies predefined regions for the filament arrangement. Filaments having substantially the same chemical composition can thus form meat emulation components whose positioning can be determined by the guide. The guide preferably also allows filaments to spatially converge.

The guide can be a single component or comprise a plurality of components. It may be preferable, for example, that the guide comprises one or more rolls that allow filaments to converge spatially on each other. A guide particularly preferably comprises a grid through the openings of which filaments are guided, so that predefined regions can be provided for the filament arrangement.

In another preferred embodiment, the method is characterized in that the filaments for the filament arrangement in predefined regions are drawn through a grid for positioning a plurality of filaments containing different ingredients for meat emulation components, and are pressed together. In particular, the filaments are bundled to form the filament arrangement and then the meat substitute product.

By pulling them through a grid, the filaments can be brought advantageously with utmost precision into a position such that they finally form meat emulation components in different regions for the meat substitute product. A plurality of filaments with substantially the same ingredients are preferably drawn through an opening of the grid to form a meat emulation component, for example muscles. Filaments, for example fat filaments, are drawn through another opening of the grid to form another meat emulation component, for example fat, in another defined region of the meat substitute product. The grid preferably has at least two openings in order to form two regions of the meat substitute product in which two different meat emulation components are respectively formed.

In other preferred embodiments, the grid may have more than two openings, for example 3, 4, 5, 6, 7, 8, 9, 10, 20, 50, 100, 200, 500, 1,000, 2,000, 5,000, 10,000 or 100,000. This advantageously allows many different meat emulation components to be formed, such that a particularly realistic emulation of a meat substitute product is formed.

It is not necessary to draw different types of filament through each opening of the grid. For example, a grid may have seven openings and only two types of filaments that are drawn through them, for example protein filaments and fat filaments. The fat filaments may then be drawn through one opening of the grid and protein filaments are drawn through the remaining six openings. This allows one region, surrounded by muscle, to be provided for fat for the meat substitute product. Similarly, a region for fat can be provided at one edge of the meat substitute product. This example serves to illustrate the method according to the invention in more detail and should not be construed as limiting in any way. It may also be preferable to form a plurality of fat regions that are surrounded by muscles. It may likewise be preferable that skin and cartilage are possible meat emulation components.

A grid advantageously allows the meat substitute product to be programmable, so that specified positions are provided for different types of filament for the meat substitute product.

Within the meaning of the invention, a grid refers to component that has openings, through each of which one type of filament can be drawn. Tribology is optimized by means of friction-reducing processes, such as ultrasound technology or surface treatment. The option of drawing one filament type through one opening can be the result of a suitable mechanism that is adjusted appropriately. For example, the preferred rolls on which the filaments are stored can be positioned accordingly, and a strand of the filament can be brought into the corresponding openings.

The grid thus acts as a kind of template that can draw specific filament types through its openings and thus provide the predefined regions for the meat emulation components. This is advantageously beneficial for the programmability of the method according to the invention.

In other preferred embodiments, the filament types are drawn through a plurality of grids, the various filament types being drawn through respective openings. It may be preferably in this respect that the filaments and/or the filament bundles cling to each other and/or taper and are subsequently bonded to one another as they pass through the openings in the grids. When using a plurality of grids, the respective openings for the filament types are preferably arranged so that they are evenly positioned. A plurality of grids may also be arranged one after the other. A particularly precise and fine positioning of the meat emulation components is advantageously achieved thereby.

In other preferred embodiments, a plurality of grids are positioned one after the other in such a way that the filaments can be transferred or introduced into openings in the grids, wherein the grid openings through which the filaments are to be introduced are positioned at different heights. This results in one or more filaments being vertically interlaced in the filament arrangement and/or after cutting the filament arrangement to provide the meat substitute product, preferably with a shift in the vertical and/or lateral direction. In particular, a starting region of a filament may be at a different height in the meat substitute product than an end region of the filament in the meat substitute product. This means that the filaments in the produced meat substitute product are not confined to being arranged along a plane. This gives rise to the possibility, rather, that the filaments may be vertically shifted (by a shift in the in z-direction), in particular due to the preferred arrangement of a plurality of grids and the filaments being introduced into openings in the grids that are at different heights. In particular, filaments may be wrapped around and/or crossed with each other. This advantageously enhances the realism of the meat substitute product. In further embodiments, therefore, the invention relates to a meat substitute product characterized in that the filaments of the meat substitute product are shifted in the vertical direction, and are wrapped around and/or crossed with each other within the meat substitute product. The realistic mimicking of meat, in particular of meat components, is advantageously improved significantly as a result, since meat components such as tendons, veins, cartilage, muscle strands, etc. do not run in straight lines along a plane, but also extend in the vertical direction as well, and can be wrapped around and/or crossed with each other.

Other components, such as predominantly two-dimensional (such as films or flat tissues) or three-dimensional structures (such as foams and/or nonwovens and/or solids with different geometries), can preferably also be introduced in a systematic manner.

Pressing the filaments together preferably means that the filaments or filament bundles are bonded to one another under pressure so that they no longer fall apart.

In another preferred embodiment, the method is characterized in that step b) is carried out in a pultrusion process.

A pultrusion process within the meaning of the invention refers preferably to a method in which filaments can be continuously produced. In particular, a pultrusion process comprises steps in which filaments are drawn off and guided onto and towards each other. In other words, a pultrusion process allows filaments to be drawn off and/or conveyed and bundled in order to provide a larger structure in terms of dimensioning. In the context of the invention, a pultrusion process has proven to be particularly advantageous for providing a filament arrangement.

A pultrusion process advantageously provides a very high level of design freedom, especially for the meat substitute product. The process allows profiles with individual properties and geometries to be produced. There are three decisive factors in pultrusion that can be specifically determined in the process, namely the desired fiber reinforcement, the binder system and the tool that defines the profile cross-section. By deliberately selecting these factors, the pultrusion process results in profiles having individual properties and cross-sections for various applications, in particular for the meat substitute product.

A pultrusion apparatus or pultrusion system for carrying out the pultrusion may include a filament shelf, a filament guide and a drawing component. A filament shelf can be formed by a plurality of rolls containing wound filaments. The filaments can preferably be drawn through a plurality of preforming stations by means of a drawing component and a filament guide through a suitable mechanical structure, so that they are brought to the desired profile shape. By using a pultrusion process, the filaments can be advantageously arranged and bonded to one another in a very targeted manner. The particular advantage of this production technology is the possibility of arranging the taste and/or nutritional composition of each filament in relation to each other. The preferred use of a grid can be as a component in the pultrusion process, in particular.

The pultrusion process is advantageously a continuous process, i.e. one that can be carried out without interruptions. This advantageously results in enormous process efficiency, as waiting and/or set-up times are minimised, thus facilitating the mass production of meat substitute products. In particular, a greater amount of meat substitutes can be advantageously produced within a significantly shorter time, which illustrates the particular effectiveness of the preferred method.

The invention therefore in another preferred embodiment to a method for producing a meat substitute product comprising the following steps:
a) providing a plurality of multi-component filaments containing water and additional proteins and/or fats, wherein each respective filament comprises a casing material and a filler material, wherein the casing material encases the filler material, wherein the filaments comprising the casing material and the filler material are provided by a spinning process and/or an extrusion process, in particular by bringing a bivalent metal ion into contact with alginate,
b) creating a filament arrangement having predefined regions for at least two meat emulation components and comprising the filaments provided in step a), wherein the filaments are bonded to one another and the filament arrangement is formed as a meat substitute product using a pultrusion process.

In another preferred embodiment, step b) is carried out in a spreading process. In a spreading process, the filaments are preferably deposited along a predefined path using pressure and/or temperature and/or a binder. The filament types are preferably also deposited in such a way that predefined regions for mimicking meat components are provided. The filaments are bonded to one another by applying an appropriate pressure and/or temperature. Spreading can be carried out robotically, in particular, i.e. automatically and in a programmed manner. The meat substitute products can also be produced advantageously in an efficient and reproducible manner by using a spreading process.

In other preferred embodiments, step b) can be carried out manually. A manual execution means in particular that the filaments can also be arranged by hand by a user. In particular, different types of filament can be pressed and bonded to one another in at least two predefined regions. It may also be preferable that a large number of people produce the meat substitute products, bonding the same filament types to one another in the same predefined regions for multiple meat emulation components. This is another advantageous way of mass-producing meat substitute products.

In another preferred embodiment, the method is characterized in that in step b) the filament arrangement is cut substantially transversely to a longitudinal axis, wherein the arrangement of filaments after a cut is preferably between 0.01 cm and 100 cm thick, preferably 2.5 cm thick. The position of the cut can be tilted in another axis to allow cuts to be made at an angle to the fiber. This may be necessary, for example when mimicking fish substitute products.

By cutting or slicing substantially transversely to a longitudinal axis, slices with desired thicknesses and/or lengths can be advantageously provided. Thus, the shape of the meat substitute product can also be regulated by the cut. It is preferred in this regard that the cut is carried out by one or more cutting tools. In particular, it is preferred that the cut is carried out when the filaments or filament bundles are bonded to one another, so that the dimensions of the meat substitute product can be determined by the cut. In particular, the cut can be made transversely to the production direction of the meat substitute product.

It may be preferable, for example, to place filament bundles having approximately 5,000-10,000 filaments per bundle in a mold and then to combine approximately 100-1,000 such filament bundles to form an imitation meat block with specific dimensions. For example, an imitation meat block may have dimensions of approximately 20×10×10 cm3. A plurality of pieces of a specific thickness can then be cut transversely to the longitudinal axis from an imitation meat block, each piece having a thickness of approximately 2.5 cm. Other dimensions may also be preferred, depending on which meat product is to be mimicked, since steak, for example, has different dimensions than a slice of ham or a burger patty. Advantageously, a variety of meat substitute products can be mimicked particularly well.

The cutting or the cut refers to a measure in which cleaving or segmentation can be performed by one or more cutting tools making one or more cuts, so that the meat substitute product and/or components for meat substitute products with the desired dimensions are provided.

In contrast to teachings of the prior art, for example of WO 2021/191906 A1, the filament arrangement is preferably cut after bundling and thus after a bundled piece has been provided. It is not the filaments as such that are cut, but preferably after the filaments have been bundled to form a filament arrangement. This advantageously achieves greater freedom of design for the meat substitute product, which means that the geometric design of the meat substitute product can be optimally regulated as part of the preferred production process.

In another preferred embodiment, the method is characterized in that in step b) the filaments are contacted with an edible binder, wherein the edible binders are selected from a group comprising alginate, albumin, preferably egg albumin, soy albumin and/or wheat albumin, and/or cereal gluten, preferably wheat gluten and/or rye gluten, particularly preferably an enzyme for cross-linking proteins, most preferably transglutaminase.

The edible binders mentioned above have proven in the food technology field to be particularly cost-efficient and process-efficient, and are also well suited for mass production. Most of these edible binders do not originate from animal products, so the meat substitute product can also be produced for vegetarians and/or vegans.

An edible binder refers to a binding agent that is edible, in particular digestible, for humans. The edible binder is used in particular to bond the filaments to one another. The edible binder is preferably brought into contact with the filament arrangement when they are brought together. This can be done during the pultrusion process, for example. This can also result during the spreading process and/or manual aggregation.

In another preferred embodiment, the method is characterized in that in step b) between 10 and 50,000 filaments, preferably between 5,000 and 10,000, are formed into bundles, and between 100 and 10,000 bundles are combined with each for the meat substitute product.

These specified ranges have proven to be particularly advantageous in that they can be formed particularly easily, in particular by cutting, combining and/or pressing together, in order to produce the meat substitute product. For mass production, it is also possible for approximately 500,000-1,000,000 filaments to be drawn off continuously and to be arranged in a tool and bonded to one another.

In the spreading process, a plurality of filaments (approximately 10-50,000) are preferably deposited simultaneously in a defined manner. The filaments can be folded over at the end of the form and relaid in a different direction. This produces a form with unidirectional filaments. The positions of the different filaments (different fat, muscle and/or connective tissue filaments) can be laid down in a defined manner on the basis of a preferably digital control system. The filaments are preferably bonded to one another using an edible binder. During laying, the binder can be distributed between the filaments using the laying tool or in addition by using a vacuum process, or in an autoclave.

In another aspect, the invention relates to a meat substitute product produced and/or producible by the method according to the invention, characterized in that the meat substitute product has predefined regions for at least two meat emulation components.

In another preferred embodiment, the invention relates to a meat substitute product produced and/or producible by a pultrusion process, characterized in that the meat substitute product has predefined regions for at least two meat emulation components.

Specifying predefined regions for at least two meat emulation components in the meat substitute product advantageously provides a certain degree of programmability. A meat emulation component can thus be specified in a particularly systematic manner with regard to the ingredients, the position and/or the appearance, for example the color. This advantageously allows meat to be mimicked in a particularly realistic manner that comes extraordinarily close to the taste and appearance of animal meat.

Due to the predefined regions, the meat substitute product that is produced has the advantage of being programmable. This means that the meat substitute product can be reproducibly produced in large numbers, without significant cost and effort being involved. The meat substitute product can be advantageously produced in a particular process-efficient manner, in particular since the predefined regions have to be defined only once beforehand, so that the meat substitute products can also be mass-produced. This means that very large volumes of meat substitute products can be produced that are substantially the same in terms of shape, appearance and taste.

Another advantage is that many different meat emulation components can be faithfully replicated, such as fat, bone, muscles, skin, tendons and/or cartilage. It is also possible, In particular, to imitate many different meat products as a meat substitute product, without having to accept restrictions on imitating particular meat products, which is a significant advantage. For example, in addition to imitations of entire pieces or cuts of meat, such as stewing steak, steak and/or minced meat, the meat substitute product may also advantageously comprise products formed from them, such as burger patties, sausages, pâtés and/or other forms of presentation. For example, the meat substitute product can mimic cuts of meat from a wide range of animals, such as beef, lamb, pork, poultry, fish and/or mussels, without being limited to these examples.

In an addition aspect, the invention relates to a meat substitute product comprising a plurality of multi-component filaments bonded to one another, characterized in that the filaments contain water, alginate and methyl cellulose, and additional proteins and/or fats, wherein each filament comprises a casing material and a filler material, wherein the casing material encases the filler material, wherein the meat substitute product has defined regions for at least two meat emulation components, wherein the regions have filaments containing different ingredients.

In another preferred embodiment, the meat substitute product comprising a plurality of multi-component filaments bonded to one another is characterized in that the filaments contain water, alginate and methyl cellulose, and additional proteins and/or fats, wherein each individual filament comprises a casing material and a filler material, wherein the casing material encases the filler material, wherein protein-containing filaments are present with a water content of more than 26% and the proteins are present in an emulsion encased by cross-linked alginate as casing material, wherein the meat substitute product has defined regions for at least two meat emulation components, wherein the regions have filaments containing different ingredients.

In another preferred embodiment, the invention relates to a meat substitute product comprising a plurality of multi-component filaments bonded to one another, characterized in that the filaments contain water, alginate and methyl cellulose, and additional proteins and/or fats, wherein individual filaments comprise a casing material and a filler material, wherein the casing material encases the filler material, wherein protein-containing filaments are present with a water content of more than 26%, wherein the protein-containing filaments contain proteins in an emulsion as filler material, encased by cross-linked alginate as casing material, wherein the meat substitute product has defined regions for at least two meat emulation components, wherein the regions have filaments containing different ingredients.

In other preferred embodiments, the water content may be more than 26%, preferably more than 30%, particularly preferably more than 50%, most preferably more than 60%.

In another preferred embodiment, the invention relates to a meat substitute product comprising a plurality of multi-component filaments bonded to one another, characterized in that the filaments contain water, alginate, and additional proteins, fats, flavorings and/or colorings, wherein individual filaments comprise a casing material and a filler material, wherein the casing material encases the filler material, wherein filaments are present with a water content of more than 26%, wherein the filaments contain proteins, fats, flavorings and/or colorings as filler material, encased by cross-linked alginate as casing material, wherein the meat substitute product has defined regions for at least two meat emulation components, wherein the regions have filaments containing different ingredients.

The filaments preferably contain proteins and/or fats as filler material.

Alginate has been shown to be an excellent substitute for collagen. Collagen itself plays a decisive role in animal meat products. The meat is perceived as tender or tough, depending on how strongly the collagen in the connective tissue is crosslinked. The collagen in the connective tissue holds the muscle tissue firmly together. The more strain is placed on a muscle, the better the collagen cross-kinks and strengthens the muscle tissue. Increased cross-linking can also occur as the animal gets older. Such meat is considered to be very tough and requires special preparation. Tender meat, in contrast, provides cuts the muscles of which have been put under little or no strain by the animals. This applies, for example, to the loin muscles of beef, pork and lamb, which produce a very tender fillet. Tender animal meat can be advantageously mimicked particularly well by the preferred meat substitute product.

The described effects of collagen could be imitated substantially exactly by the addition of alginate in the meat substitute product according to the invention. In particular, alginate can also be used to regulate, in particular to optimize, the preparation and/or cooking of the meat substitute product.

The methyl cellulose in the meat substitute product likewise has advantageous effects on the meat substitute product. Water and/or fat can be bound by the methyl cellulose and become more cross-linked, especially during heating, for example during frying or roasting. Moisture, i.e. water, is chemically bound and thus stored in the filler by the methyl cellulose. This is particularly relevant in that soy and/or pea proteins, for example, have only low, limited water absorbencies. The preferred use of methyl cellulose advantageously allows water to be stored even at high temperatures. The meat substitute product can therefore replicate the taste experience in an advantageously accurate manner with regard to residual moisture. In particular, moisture can leak out when the meat substitute product is cut at an edge, which was not readily possible with prior-art meat substitute products before now.

The proteins mentioned provide structure and are nutrient sources. Fats can also be relevant for the enjoyment and consumption of the meat substitute product. However, the tenderness and juiciness of the meat substitute product are also influenced advantageously by the fat content, above all. For example, a certain proportion of fat in the meat substitute product is a carrier of fat-soluble vitamins and/or flavorings.

The defined regions in the meat substitute product provide specific meat emulation components for imitating meat in a particularly realistic manner. In particular, an animal meat product can be simulated in great detail. For example, the meat product can replicate muscles, tendons, skin areas, cartilage and/or bones in the defined regions. A very good impression of eating real animal meat can be produced for the consumer, which is particularly advantageous for individual enjoyment of the meat substitute product. The defined regions in the meat substitute product are characterized by each region containing one type of filament.

In another preferred embodiment, the meat substitute product is characterized in that the filaments are arranged substantially along a longitudinal axis.

Aligning the filaments substantially along a longitudinal axis advantageously means that the structure of animal meat, in particular its marbling, can be imitated particularly well. Aligning the filaments substantially along a longitudinal axis also has an advantageous effect on the taste experience, in that a particularly aromatic, juicy and/or tender meat substitute product can be provided.

In another preferred embodiment, the meat substitute product is characterized in that the respective meat emulation components are formed of filaments containing different ingredients, wherein meat emulation components for muscle emulation and fat emulation are present.

As already noted, the meat substitute product preferably has regions containing meat emulation components and where animal meat components are to be imitated. For example, a meat substitute product may have to include mimicked muscle and mimicked meat in order to replicate animal muscles and fats accordingly. A mimicked muscle refers to a region for mimicking muscles, and mimicked fat refers accordingly to a region for mimicking fats. To that end, these regions have filaments containing different ingredients in order to form such regions. Protein filaments are preferred for mimicking muscle, whereas fat filaments are preferably used to mimic fat.

There is preferably also a plurality of defined regions that imitate different components of animal meat in respect of their position and ingredients and which are thus able to replicate the taste as well. The meat substitute product is characterized by a particularly realistic replication of real meat and is particularly cost-efficient and process-efficient to produce. The meat substitute product according to the invention also provides the consumer with a taste experience that is particularly enjoyable.

The marbling can be adjusted with an accuracy of up to approximately 150 μm (microns). The accuracy is determined by the diameter of the filaments. This allows all manner of fat/muscle fiber composition to be replicated, from rib-eye to Wagyu to fillet steaks. It is also possible to create taste experiences that have not been possible so far with classical livestock farming.

In another aspect, the invention relates to a system which is configured to carry out the inventive method for producing a meat substitute product. The system may include components, equipment, apparatus, etc., for performing preferred steps of the method. For example, it may be preferred that the system comprises a spinning system, a coagulation bath, a guide, a grid and/or a pultrusion system as components. Structural features with which the preferred method can be carried out are preferably to be understood as components of the preferred system. The system comprises those components, in particular all the components, with which the preferred method and/or preferred steps of the method can be carried out.

The system for producing a meat substitute product is preferably configured for a) providing a plurality of multi-component filaments containing water and additional proteins and/or fats, wherein individual filaments comprise a casing material and a filler material, wherein the casing material encases the filler material, and b) creating a filament arrangement comprising the filaments provided in step a), wherein the filament arrangement has predefined regions for at least two meat emulation components, wherein the filaments are bonded to one another and the filament arrangement is formed as a meat substitute product using a pultrusion process.

In another preferred embodiment, the system is characterized in that the casing material comprises alginate, wherein preferably the casing material forms an outer casing comprising cross-linked alginate on an outer side of the filament, and alginate is present inside the filler material.

In another preferred embodiment, the system is characterized in that the filler material includes a thickener, a binder and/or emulsifier, wherein the filler material preferably includes methyl cellulose, and/or the filler material is selected from a group comprising alginate, fat, proteins, preferably soy proteins and/or pea proteins and/or sunflower protein, calcium lactate, calcium chloride, water, methyl cellulose, lipids, flavorings and/or colorings.

In another preferred embodiment, the system is characterized in that production of the multi-component filaments is carried out before step a), preferably by a spinning process and/or an extrusion process.

A spinning system preferably refers to a system which is configured to carry out a spinning process. An extrusion system preferably refers to a system which configured to carry out an extrusion process. In particular, the spinning system and/or extrusion system are preferred components of the system.

In another preferred embodiment, the system is characterized in that the system includes a conveying means, so that a spinning mass containing water, alginate and methyl cellulose, and additional proteins and/or fats, can be conveyed to a spinning nozzle, and/or the temperature between the conveying means and the spinning nozzle is between 20° C. and 180° C. The system preferably has a spinning nozzle for that purpose, wherein the spinning nozzle is preferably a component of the spinning system. This spinning nozzle is therefore also a preferred component of the system.

In another preferred embodiment, the system is characterized in that the filaments can be brought into contact with a solution containing calcium, calcium lactate and/or alginate after exiting a spinning nozzle, wherein the temperature of the solution is preferably between 0° C. and approximately 80° C.

In another preferred embodiment, the system is characterized in that the filaments can be drawn off from a spinning nozzle, dried and/or stretched and then stored, preferably on a roll, before the filaments can be used in step b).

In another preferred embodiment, the system is characterized in that the system has a guide, so that the filaments for the filament arrangement in predefined regions can be drawn through the grid for positioning a plurality of filaments containing different ingredients for meat emulation components, and can be pressed together.

In another preferred embodiment, the system is characterized in that in step b) the filaments can be brought into contact with an edible binder, wherein the edible binders are selected from a group comprising alginate, albumin, preferably egg albumin, soy albumin and/or wheat albumin, and/or cereal gluten, preferably wheat gluten and/or rye gluten, particularly preferably an enzyme for cross-linking proteins, most preferably transglutaminase.

In another preferred embodiment, the system is characterized in that the filaments have a cross-sectional area between 0.03 and 3 mm2, preferably between 0.04 and 2.5 mm2, particularly preferably between 0.08 and 0.3 mm2, and/or between 50 and 10,000 filaments, for example 100 to 5,000, or 500 to 2,000 filaments, are bonded to one another in the meat substitute product.

A person of average skill in the art will realize that technical features, definitions and advantages of the embodiments that apply to the method according to the invention for producing a meat substitute product, also apply in equal measure to the meat substitute product that can be produced by the method, in particular to meat substitute product comprising a plurality of multi-component filaments bonded to one another, and vice versa. Furthermore, technical features, definitions and advantages of the embodiments that apply to the method according to the invention for producing a meat substitute product also apply in equal measure to the preferred system, and vice versa.

The method and the meat substitute product according to the invention shall now be described in more detail with reference to examples, without being limited to these examples.

### FIGURES

### Brief Description of the Drawings

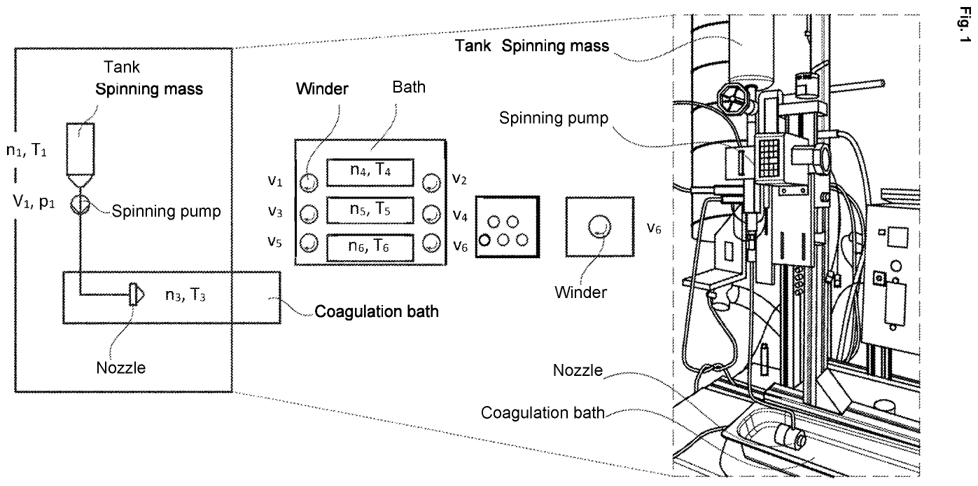

FIG. 1 shows an apparatus for carrying out a spinning process

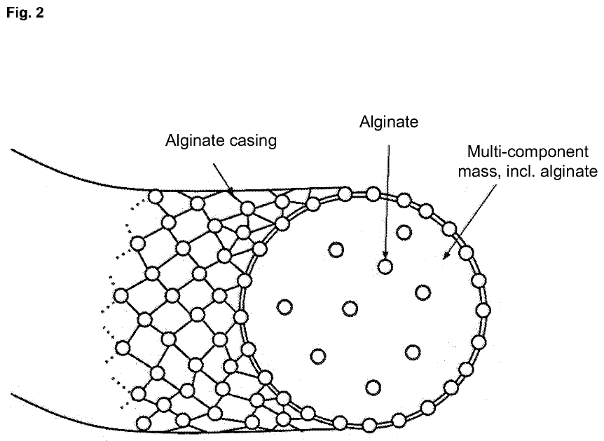

FIG. 2: shows a schematic view of a filament

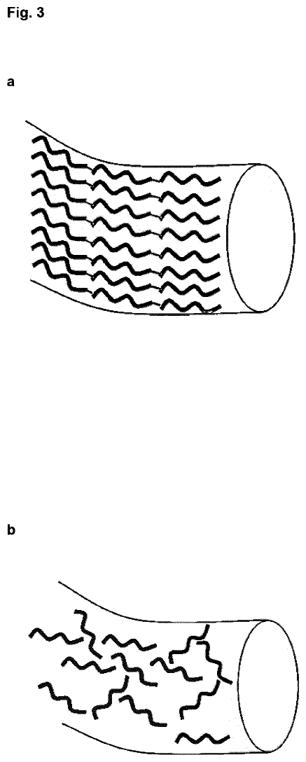

FIG. 3 shows a schematic view of the proteins in a filament

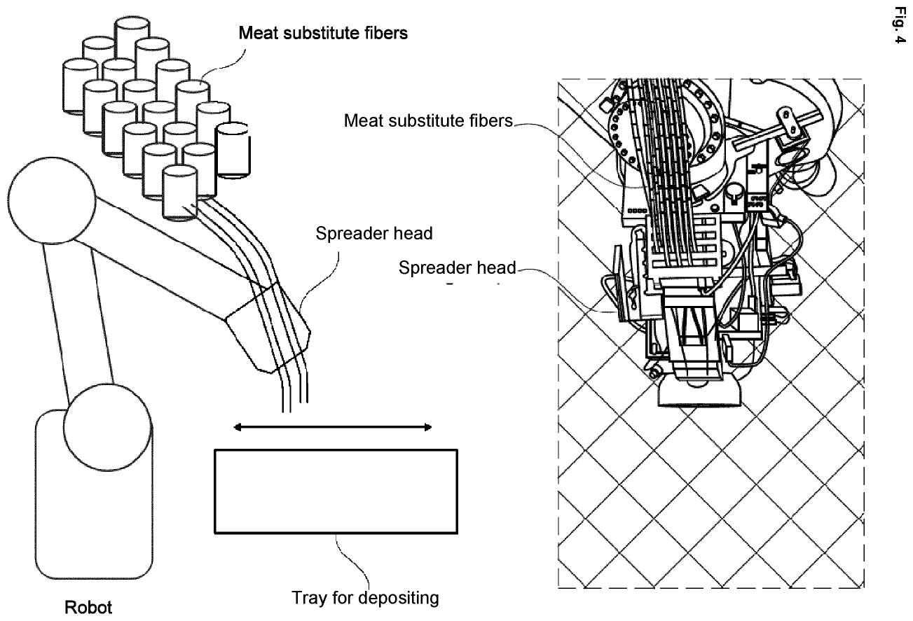

FIG. 4 shows an apparatus for carrying out a laying process

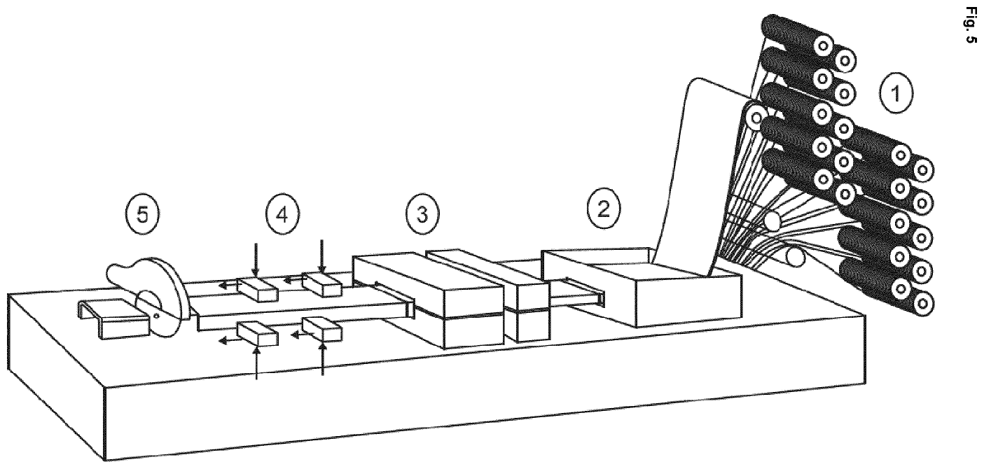

FIG. 5 shows a schematic view of a pultrusion apparatus

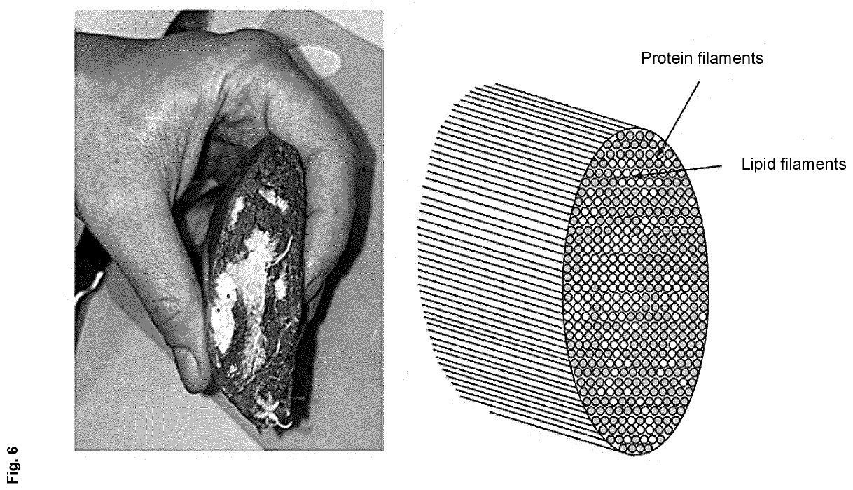

FIG. 6 shows a meat substitute product

### DETAILED DESCRIPTION OF THE DRAWINGS

FIG. 1 shows an apparatus for carrying out a spinning process. A spinning process, in particular a wet spinning process, can be used in the context of the invention to provide the filaments. FIG. 1 summarizes the essential components for performing the process.

The spinning mass is filled in a low-viscosity state into a tank. The tank can be pressurised to improve the flow behavior of the spinning mass. The tank can also be heated. It is better to have a heating section between the spinning pump and the spinning nozzle. The spinning mass is conveyed by a spinning pump. The spinning pump is speed-controlled and conveys a defined volume per revolution. Upstream from the spinning pump there is a fine mesh screen to obtain uniformity of the spinning mass and to filter out any particles that could clog the spinning nozzles.

The spinning pump pushes the spinning mass through the spinning nozzle. Between the spinning nozzle and the spinning pump, a pressure is built up that is dependent on the viscosity of the spinning mass and the orifice of the spinning nozzle.

The spinning nozzle determines the geometry and the number of parallel filaments that are produced. The geometry of the cross-sections can be controlled via the shape of the hole. The geometry of the filaments also depends on the swelling characteristics of the filaments downstream from the nozzle and can be strongly influenced by the draw-off speed of a winder. A flow can also be used in the coagulation bath to stretch the filament.

Different components are combined with each other to form the spinning mass. A distinction must be made here between three main structural components: A protein is used which can be cross-linked within one to 60 minutes at a temperature between 2° and 80° C., an alginate is used which can be cured with the aid of setting agents (for example calcium lactate), and methyl cellulose is used, which can bind water and fat and cross-links more strongly when heated. In the wet spinning process, the calcium and/or the calcium lactate is in the coagulation bath.

FIG. 2 shows a schematic view of an alginate casing containing calcium and/or calcium lactate being formed in the coagulation bath. A network is formed on the outside of a filament by an alginate casing, the alginate being present in a low concentration, for example approximately 1-5%.

FIG. 3 shows a schematic view of the orientation of the proteins in a filament. In FIG. 3a, the proteins are aligned substantially along a longitudinal axis of the filament, whereas in FIG. 3b they are not aligned. An aligned arrangement substantially along the longitudinal axis of a filament is preferred in order to obtain better mechanical properties. The respective arrangement can be achieved by stretching the filaments, for example.

FIG. 4 shows a schematic view and a real-life view of an apparatus for carrying out a spreading method. In the spreading process, a plurality of filaments (e.g. 10-50,000) are deposited simultaneously in a defined manner. The filaments can be folded over at the end of the form and relaid in a different direction. This produces a form with unidirectional filaments. The positions of the different filaments (different fat, muscle and connective tissue fibers) can be laid down in a defined manner on the basis of the digital control system for the spreading apparatus. The filaments are bonded to one another using an edible binder. During laying, the binder can be distributed between the filaments using the laying tool or in addition by using a vacuum process, or in an autoclave.

FIG. 5 shows an apparatus for carrying out a pultrusion process. In this continuous production process, a profile is created by the systematic binding of filaments and binder systems. The pultrusion process advantageously provides a very high degree of design freedom for the filaments. The process allows profiles with individual properties and geometries to be produced for the meat substitute product.

At position 1, the filaments are on rolls. At position 2, the filaments coming off the rolls are impregnated in an impregnation trough which can contain an edible binder, for example, by means of which the filaments are bonded to one another. Section 3 can have a plurality of possible tools for obtaining the desired form of the meat substitute product. For example, the filaments may be heated by applying a higher temperature and then cured. At position 4, the profile can then be stretched continuously on the tool by means of a tandem rake. At position 5, the profile can be cut to shape in order to obtain the final dimensions, in particular the desired length.

FIG. 6 is a photograph and a corresponding schematic arrangement of the filaments for mimicking specific meat components. The Figure shows particularly well the programmability of the meat substitute product, in that different filaments, in this case protein filaments and lipid filaments as well as connective tissue holding the filaments together, have firmly assigned positions. This allows a meat substitute product to be created that comes extraordinarily close to an animal meat product.

1-15. (canceled)

16. A method for producing a meat substitute product, the method comprising the following steps:
a) providing a plurality of multi-component filaments containing water and at least one of additional proteins or additional fats;
b) forming a filament arrangement having a first predefined region and a second predefined region, comprising the sub-steps of:
b-1) grouping filaments of a first filament type into bundles and assigning the filaments of the first filament type to a first predetermined position in the meat substitute product for forming the first predefined region, the first predefined region being configured for forming a first meat imitation component;
b-2) grouping filaments of a second filament type into bundles and assigning the filaments of the second filament type to a second predetermined position in the meat substitute product for forming the second predefined region, second predefined region being configured for forming a second meat imitation component; and
b-3) bonding the filaments together; and
c) arranging the filament arrangement to form the meat substitute product.

17. The method of claim 16, wherein each filament has a cross-sectional area between 0.03 mm² and 3.0 mm².

18. The method of claim 16, wherein the filaments of the first filament type comprises filaments of substantially the same ingredients.

19. The method of claim 16, wherein the filaments of the second filament type comprise substantially the same ingredients.

20. The method of claim 16, wherein each filament comprises a filler material and a casing material encasing the filler material.

21. The method of claim 20, wherein the casing material comprises alginate and the casing material forms an outer casing comprising cross-linked alginate on an outer side of the filament; and
wherein the filler material comprises alginate.

22. The method of claim 16, wherein the step of providing the plurality of multicomponent filaments comprises producing the multi-component filaments by a spinning process.

23. The method of claim 22, wherein the step of producing the multi-component filaments by the spinning process comprises conveying a spinning mass comprising water, alginate and methyl cellulose, and at least one of additional proteins or additional fats to a spinning nozzle via a conveying means.

24. The method of claim 22, wherein the step of producing the multi-component filaments by the spinning process comprises contacting the filaments after exiting a spinning nozzle with a solution containing at least one of calcium, calcium lactate, or alginate.

25. The method of claim 22, wherein the step of producing the multi-component filaments by the spinning process comprises at least one of drawing the filaments from a spinning nozzle, drying the filaments, or stretching the filaments and then storing the filaments.

26. The method of claim 16, wherein the step of forming the filament arrangement comprises drawing the filaments through an array of gitters to arrange and bundle the filaments.

27. The method of claim 24, wherein the step of forming the filament arrangement further comprises at least one of drawing off or conveying the filaments, arranging the filaments, and bonding the filaments using a pultrusion process.

28. The method of claim 16, wherein each bundle comprises 10 to 50,000 filaments and wherein the meat substitute product comprises 100 to 10,000 combined bundles.

29. The method of claim 16, wherein the step of bonding of the filaments comprises:
pressing the filaments of the first filament type together to bond the filaments of the first filament type; and
pressing the filaments of the second filament type together to bond the filaments of the second filament type.

30. The method of claim 16, wherein the step of forming the filament arrangement comprises depositing the filaments of the first filament type and the second filament type using at least one of pressure, temperature, or a binder along a predetermined path to form the first predefined region and the second predefined region.

31. The method of claim 16, wherein the step of arranging the filament arrangement comprises at least one of compressing or cutting at least one of the filaments or the bundles.

32. The method of claim 16, wherein the step of forming the filament arrangement comprises contacting the filaments with an edible binder, wherein the edible binder is selected from a group comprising alginate, albumin, and cereal gluten and comprises an enzyme for cross-linking proteins.

33. The method of claim 16, wherein the step of forming the filament arrangement comprises regulating a configuration of the filaments to mimic at least one of a density, a number, or a size of, a strength, or an external appearance of a meat component to adjust a texture of the meat substitute product.

34. The method of claim 16, wherein the filaments of the first filament type comprise a first group of ingredients, the filaments of the second filament type comprise a second group of ingredients, and the first group of ingredients is different from the second group of ingredients.

35. The method according to claim 16, wherein the filaments of the first filament type form a first meat emulation component and the filaments of the second filament type form a second meat emulation component, the first and second meat emulation components each being designed to imitate a position and a composition of a meat component selected from a group of muscle fibres, fat, tendons, skin, cartilage and bones.

36. A meat substitute product comprising a filament arrangement including a plurality of multi-component filaments, the filaments each having a cross-sectional area between 0.03 mm² and 3.0 mm² and comprising water and at least one of additional proteins or additional fats;
wherein the filament arrangement comprises:
a first predefined region forming a first meat emulation component, the first meat emulation component being formed by filaments of a first filament type combined into bundles and assigned a first position in the filament replacement product; and
a second predefined region forming a second meat emulation component, the second meat emulation component being formed by filaments of a second filament type combined into bundles and assigned to a second position in the meat substitute product; and
wherein the filaments are interconnected in the filament arrangement.

37. The meat substitute product of claim 36, wherein the filaments comprise water, alginate and methyl cellulose, and at least one of additional proteins or additional fats.

38. The meat substitute product of claim 37, wherein the filaments are arranged substantially along a longitudinal axis.

39. The meat substitute product of claim 37, wherein the filaments of the first filament type comprise a group of first ingredients, the filaments of the second filament type comprise a second group of ingredients, and the first group of ingredients is different from the second group of ingredients.
